(19) United States
(12) Patent Application Publication
(10) Pub. No.: US 2008/0106373 A1
(43) Pub. Date: May 8, 2008

(54) Compensating For Acquisition Noise In Helper Data Systems

(75) Inventors: Thomas Andreas Maria Kevenaar, Eindhoven (NL); Alphons Antonius Maria Lambertus Bruekers, Eindhoven (NL); Minne Van Der Veen, Eindhoven (NL); Antonius Hermanus Maria Akkermans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/916,096

(22) PCT Filed: May 23, 2006
(86) PCT No.: PCT/IB06/51645

§ 371 Date: Nov. 30, 2007

(30) Foreign Application Priority Data
Jun. 1, 2005 (EP) 05104744.7

(51) Int. Cl. G05B 19/00

(52) U.S. Cl. 340/5.8

(57) ABSTRACT

The invention relates to a method of authenticating a physical object using a helper data and a control value associated with a reference object, the method comprising: acquiring a metric data of the physical object, generating a first property set using a noise compensating mapping on input data derived from information comprising said helper data and metric data, establishing a sufficient match between said physical and reference object using said property set and control value. The method further comprising a step to generate a noise measure, the step comprising the following sub-steps: reconstructing the output of a noise robust mapping generated during the enrolment of the reference object using the noise compensating mapping, and generating the noise measure by calculating the difference between the input to the noise compensating mapping and the output of the noise robust mapping. Also provided are an apparatus and system configured to carry out the method.

The invention relates to a method of authenticating a first physical object using a first helper data and a first control value associated with a reference object, the method comprising the following steps: acquiring a metric data of the first physical object, generating a first property set using a noise compensating mapping on input data derived from information comprising the first helper data and the metric data, establishing a sufficient match between the first physical object and the reference object using the first property set and the first control value.

Identification and authentication are commonly used techniques for establishing identity, where identity can be the identity of a person or an object. Prime examples of application areas for identification and authentication are access control for buildings or information, authorization of payments and or other transactions. Identification and authentication are closely related concepts with a subtle difference.

During the process of authentication an object with an alleged identity is offered for authentication. Subsequently characteristics of the object offered for authentication are matched with those of the enrolled object with the alleged identity. If a sufficient match is found the identity of the object being authenticated is said to be the alleged identity. Authentication thus deals with matching one object, being the one authenticated, to one enrolled object associated with the alleged identity.

During the process of identification of an object, the identity of a physical object is established by matching characteristics of the object with characteristics of previously enrolled objects. If a successful match is found the identity of the object being authenticated is said to be the identity of the matching object. The identification process can be seen as a series of authentication processes where a physical object is repeatedly authenticated with different enrolled objects.

In practical authentication systems the authentication process is generally preceded by an enrolment process. During this enrolment characteristics of the object at hand are measured and stored. Based on the measured data so-called template data is generated that is representative for the physical object. Template data generation may involve processing the measured data to filter out characteristics of a particular object. The resulting template data is used during the authentication process for matching measured characteristics with characteristics of enrolled objects.

Template data may at first glance present little value. However when template data is used on a regular basis to perform financial transactions its value becomes obvious. Furthermore in case of biometric authentication systems template data may also comprise privacy sensitive biometric data, and therefore have an even greater value.

International application WO 2004/104899 (PHNL030552) discloses a solution to this security/privacy problem, in the form of a helper data system for authentication of a physical object.

A helper data system provides the authentication terminal with so-called helper data and a control value. Both are generated during enrolment and are used instead of the actual template data. The helper data is generated using the template data, but characteristics of the template data are obfuscated in such a way that there is hardly any correlation between the template data and the helper data. The control value is generated in parallel with the helper data and serves as a control value for the authentication process.

The helper data and control value are used during authentication. First the helper data is combined with metric data acquired from the physical object (e.g. facial feature data). This combined data is subsequently “condensed” into a second control value. This second control value is matched with the control value generated during enrolment. When these control values match authentication is successful.

During authentication (bio)metric data is acquired from the physical object by means of a data acquisition means such as a fingerprint scanner. Generally noise is introduced in the metric data during the data acquisition process. This noise can be caused by a variety of reasons such as: process spread in manufacturing acquisition means, aging and or wear of the acquisition means. Knowledge of acquisition noise can be used to improve the false rejection ratio of authentication. Unfortunately the template data that is needed to quantify acquisition noise is not available during the authentication phase in a helper data system.

It is an object of the present invention to quantify a noise measure for an acquisition noise component introduced by the data acquisition process during the authentication of a physical object using both a helper data and a control value, without the need to have access to the template data associated with said physical object.

The objective is realised in that the method as set forth in the introductory paragraph is further characterized in that it comprises a step to generate a noise measure quantifying the noise introduced during data acquisition, said step comprising the following sub-steps: reconstructing the output of a noise robust mapping as generated during the enrolment of the reference object using the noise compensating mapping, and generating the noise measure by calculating the difference between the input to the noise compensating mapping during authentication and the reconstructed output of the noise robust mapping as generated during the enrolment of the reference object.

Authentication methods that employ template protection by means of helper data comprise a noise robust mapping applied during enrolment for generating the helper data and a noise compensating mapping applied during authentication. The noise robust mapping is used to provide resilience to measurement errors in the (bio)metric data acquired from the physical object. The noise compensating mapping can be interpreted as the inverse of the noise robust mapping, where the noise robust mapping adds noise resilience, the noise compensating mapping uses this to reconstruct the original message in the presence of noise. Provided the noise robust mapping is sufficiently robust, or the measurement noise is sufficiently small, successful authentication is possible.

A method according to the present invention acquires (bio)metric data from the physical object being authenticated and combines this with the first helper data generated during enrolment of the reference object. The combined data is subsequently used as input for the noise compensating mapping that generates the first property set. This is used to establish a sufficient match between information derived from the first property set and the first control value. The latter generally requires the generation of a third control value from the first property set, followed by a comparison of the both the first and third control value. If the control values match authentication is successful.

The present method capitalizes on the fact that during a successful authentication the noise compensating mapping provides sufficient resilience to compensate for acquisition noise. As a result it is possible to establish a noise measure during a successful authentication quantifying the acquisition noise without using the actual template data.

In case of a successful authentication the first property set can be used to reconstruct the property set C generated during enrolment of the reference object by applying the noise robust mapping on the first property set. Subsequently it is possible to quantify the difference between the input to the noise compensating mapping applied during authentication of the physical object, and the output of the noise robust mapping used during enrolment of the reference object.

During a successful authentication the reference object is proven to be the physical object. As a result a noise measure can be established by subtracting the input to the noise compensating mapping from the reconstructed output of the noise robust mapping.

For certain types of noise robust/compensating mappings this procedure can be further simplified, by capitalizing on the characteristics of the mappings in question. Systematic error correcting code decoding algorithms, hereafter referred to as systematic ECC decoding algorithms, are prime examples of advantageous noise compensating mappings. A systematic ECC is an ECC where both the input and output are defined using the same alphabet and where in the input and output data and parity symbols are formatted in the same fashion. In a codeword of a systematic ECC, the data symbols are included without further coding, and can be recognised as such.

The ECC decoding algorithm maps an input codeword onto the nearest codeword where data and parity match. When the number of errors in the input codeword is lower than the maximum number of errors that can be corrected, the output codeword will comprise the original noise free data and its associated parity.

When the authentication process in a helper data system uses a systematic ECC, the reconstructed first property set is a codeword where data and parity match. When this code word is subsequently used as input to a noise robust mapping that applies a systematic ECC encoder algorithm the output of the noise robust mapping is identical to the input code word. This in turn implies that when during a successful authentication the first property set S1 is used as input for a systematic ECC encoder the resulting output equals first property set S1. This further implies that the property set S1 is identical to property set C generated during enrolment of the reference object. As a result establishing a noise measure here corresponds to subtracting the input of the noise compensating mapping from the output of the noise compensating mapping.

In case the noise compensating mapping selected is a non-systematic ECC decoding algorithm, and such a code e.g. uses a different input and output alphabet, an additional step is needed to determine the noise measure, as it is no longer possible to subtract the input and output of the noise compensating mapping. In this case the noise measure can then be computed by applying the noise robust mapping on the output of the noise compensating mapping, and subsequently subtracting the input of the noise compensating mapping from the output of the noise robust mapping.

The noise measure established in this way encompasses all kinds of noise introduced by the acquisition process ranging from scratches on the scan surface of an acquisition means to faulty pixels on a CCD.

A further step to establish a more reliable noise measure related to the acquisition means, and not related to individual data acquisitions, is to collect multiple noise measures and subsequently filter out non-correlated noise components. One of the simplest methods to do so would be to generate a noise measure by averaging over multiple noise measures, preferably for multiple objects.

The same method can be used in controlled circumstances, where there is limited or no need for averaging, for example during calibration. In fact the present method allows the calibration of an apparatus for authentication using helper data, by reusing the infrastructure at hand, without providing the person calibrating the terminal with information with respect to the template data used and or the underlying algorithms.

Once a noise measure has been established it can be used to compensate for the noise introduced during data acquisition. In fact two different types of noise compensation can be applied:

static noise compensation;

dynamic noise compensation.

An example of an apparatus applying static noise compensation is an apparatus for authentication of a physical object in which the noise measure as generated during either an earlier authentication or during calibration is combined with the helper data and the metric data acquired from the physical object.

By compensating for the time-invariant noise component introduced by the acquisition means the full noise resilience of the noise robust mapping can be used by the noise compensating mapping to suppress noise of time-variant nature, such as transient or intermitting noise sources.

Alternatively the present invention facilitates a dynamic noise compensation approach where a noise measure is determined and updated during authentication, such that the apparatus or system used for authentication of a physical object can track gradual changes in the acquisition means resulting from scratches and or dirt, or degradation resulting from “aging” of the acquisition means.

Although noise measures are effectively established during authentication these noise measures can be gathered and stored and used as input for further processing to establish a better noise measure. This noise measure can than be used during further authentication processes. As a result noise measure updates do not need to coincide with successful authentication, but can take place at arbitrary intervals.

The present invention can also be applied in a system for authentication of a physical object using both a helper data and a control value. Such a system can comprises one or more servers for data storage, and one or more clients interconnected by means of a network, the present method could be implemented in a distributed fashion, where data acquisition is located in the client, and where noise measure calculation and further processing are centralized at one or more servers.

Alternatively the role of the servers in the system can be reduced to helper data and control value storage, and leave data acquisition, noise measure generation, and noise measure storage to the respective clients.

In particularly in a large distributed system monitoring of noise measures may help to signal the need for maintenance or replacement of individual clients and thereby prevent system failures. The noise measure is indicative of the noise introduced by the acquisition means, and thereby indicative of the likelihood of authentication failures. Consequently it can be used as diagnostic information for individual clients.

These and other aspects of the biometric authentication system will be further elucidated and described with reference to the drawing, in which:

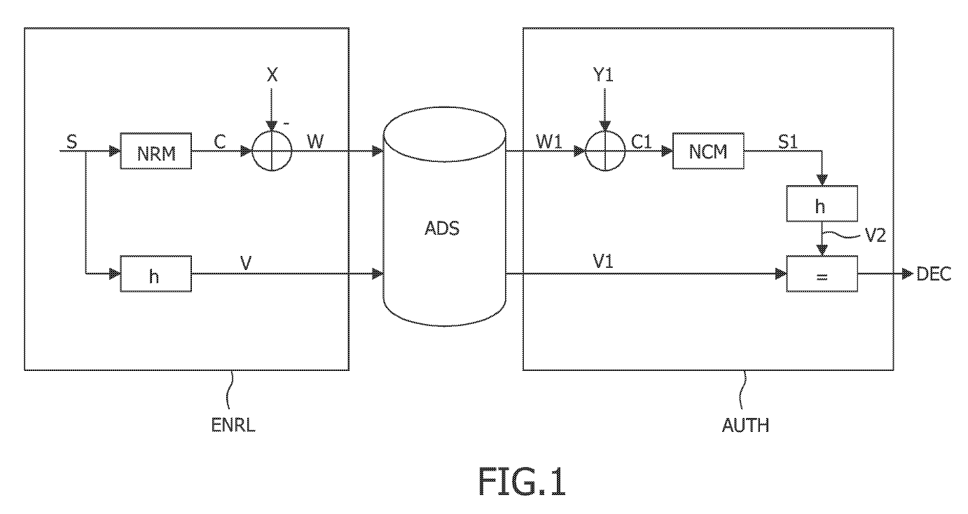

FIG. 1 is a block diagram of a helper data system for authentication of a physical object according to the prior art.

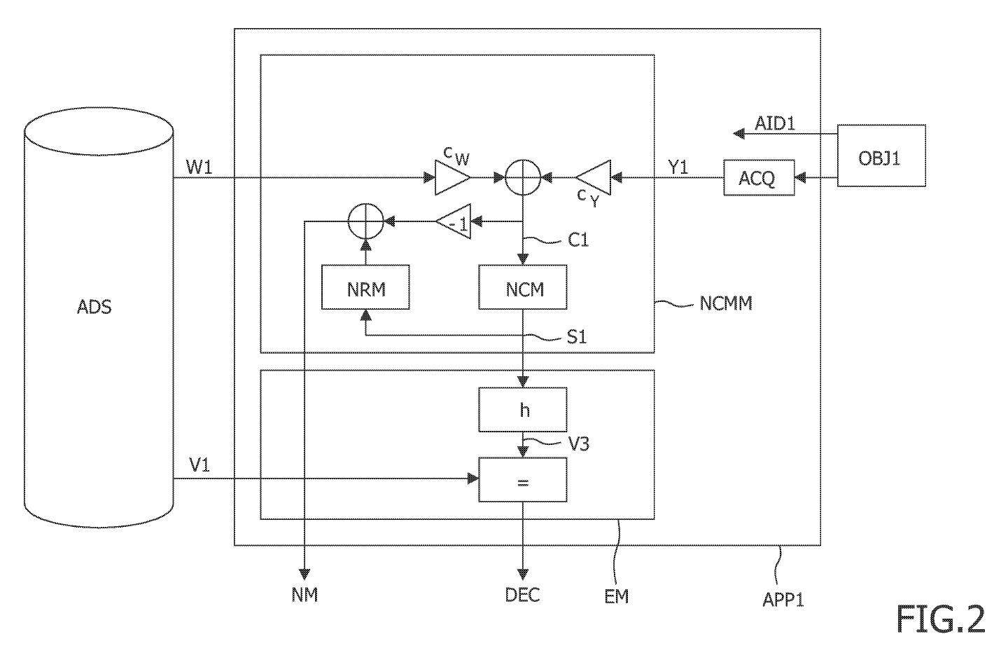

FIG. 2 depicts an apparatus for authentication of a first physical object, arranged to generate a new noise measure according to the present invention.

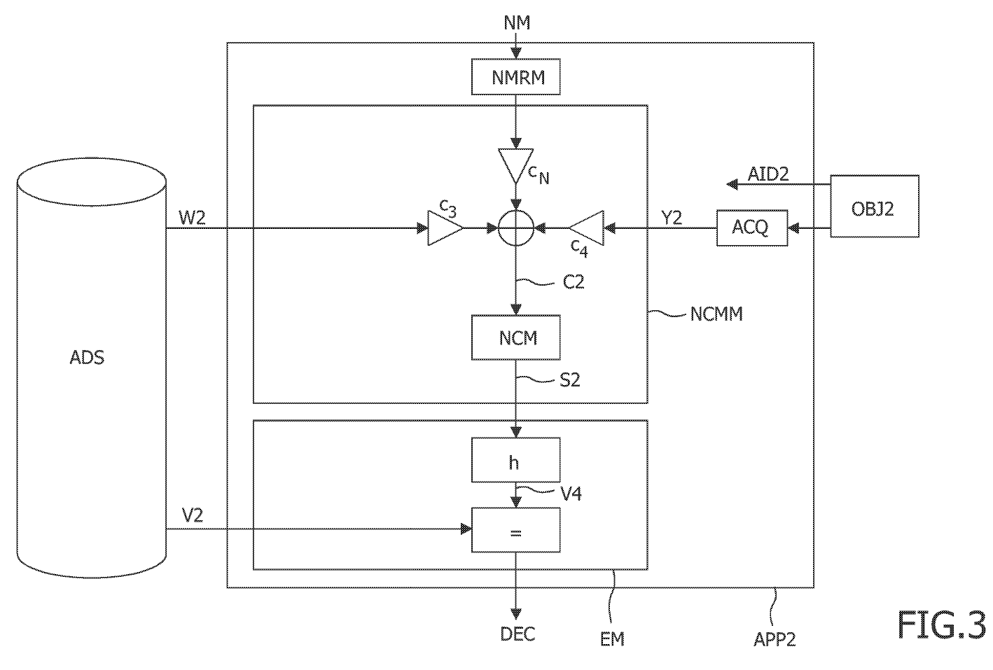

FIG. 3 depicts an apparatus for authentication of a second physical object, arranged to use a noise measure generated according to the present invention.

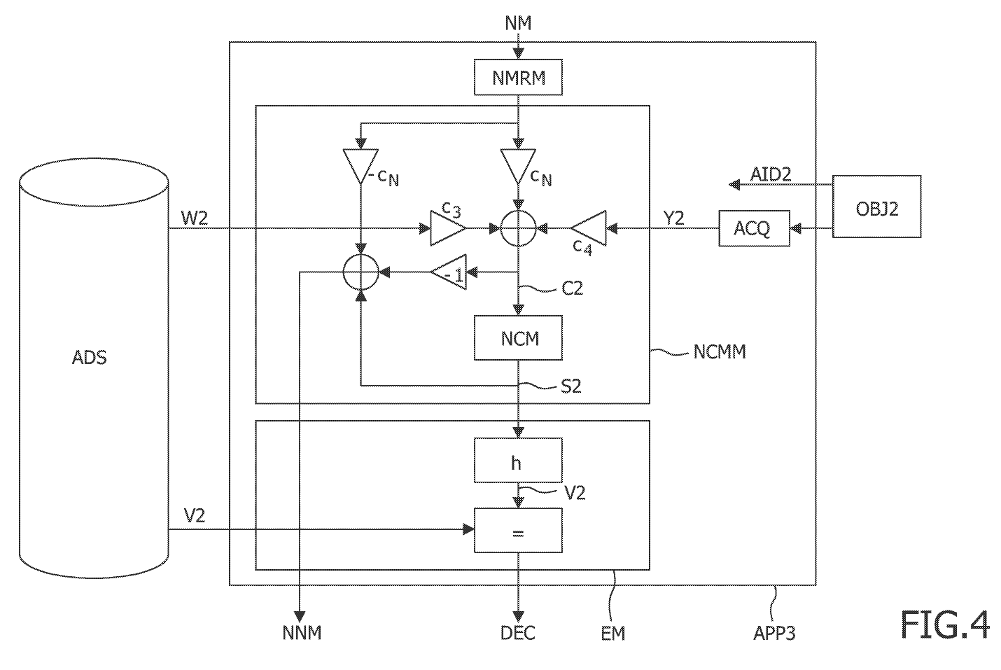

FIG. 4 depicts an apparatus for authentication of a second physical object, arranged to use a noise measure generated according to the present invention and to generate a new noise measure according to the present invention.

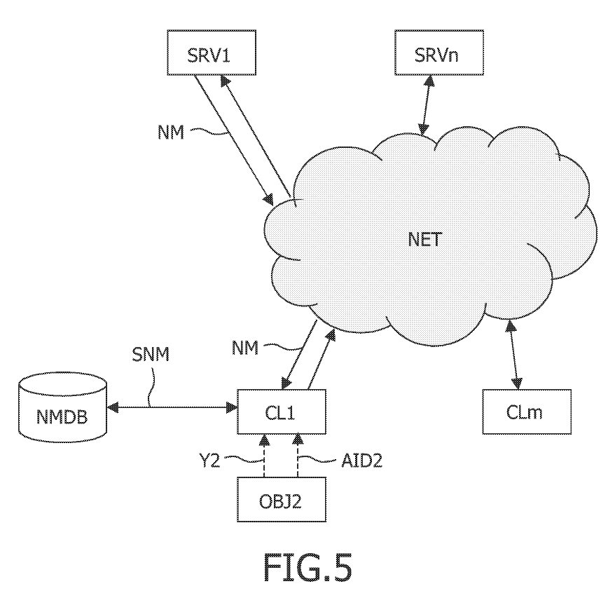

FIG. 5 is a block diagram of a system for authentication of a physical object arranged to use a noise measure generated according to the present invention.

Throughout the drawing, the same reference numeral refers to the same element, or an element that performs the same function.

Although the present invention is described primarily for use in authentication systems, the present method can be applied to identification systems in an equally advantageous way.

During the authentication process typically a metric obtained from a physical object with an alleged identity is matched with enrolment data associated with a reference object with the alleged identity. During an identification process typically a metric obtained from a physical object without an alleged identity is matched with enrolment data associated with a series of reference objects to establish an identity.

Both processes effectively perform a comparison of a metric obtained during authentication/identification, and compare this with enrolment data of at least one reference object. Although the examples focus primarily on issues related to the authentication process, a person skilled in the art can design alternative embodiments for the identification of a physical object without departing from the scope of the appended claims.

Before explaining the present invention in more detail the general concept of an authentication system applying template protection is further elucidated using the block diagram in FIG. 1. FIG. 1 depicts an enrolment process ENRL on the left hand side, during the enrolment process ENRL a helper data W and a control value V are generated for the object being enrolled. This data is subsequently stored in the authentication data set ADS, located in the middle. During the authentication process AUTH, depicted on the right hand side, a physical object (not shown in FIG. 1) with an alleged identity is authenticated.

Initially the authentication data set ADS is searched for a reference object with the alleged identity. If there is no such reference object the authentication will fail. Provided the reference object is found, a first helper data W1 and an accompanying first control value V1 associated with the alleged identity are retrieved from the authentication data set ADS. This data is used to decide whether or not the physical object being authenticated sufficiently matches the reference object. If a sufficient match is found the authentication result is positive.

Assume that the helper data system is used to authenticate persons using biometric data in the form of fingerprint data. Furthermore assume that the biometric template data comprises a graphical representation of the lines and ridges of the core area of the fingerprint. Issues such as the orientation and localization of the core area during acquisition are beyond the scope of the present description.

During the enrolment process ENRL a person presents his or her finger to a fingerprint scanner. The result from one or more fingerprint scans is used to construct a biometric template X. In addition a, possibly secret, property set S is chosen. The property set S is mapped onto a property set C by means of a noise robust mapping NRM.

Subsequently the property set C is combined with biometric template X to produce a helper data W. In a practical helper data system the property set S and the noise robust mapping NRM are chosen such that the resulting helper data W does exhibit little or no correlation with the biometric template data X. As a result the use of helper data W does not expose the biometric template data X to malicious users.

To enable authentication the enrolment process also involves the generation of a control value V. Control value V is generated using the property set S. Although the control value V can be identical to the property set S this is not advisable in systems where security is an issue. In a secure helper data system it should not be possible to reconstruct the property set S using the control value V. This requirement is satisfied when the control value V is generated by application of a one-way mapping on the property set S. A cryptographic hash function is a good example of such a one-way mapping. If security is not critical a non one-way mapping could be used. Finally the pair of helper data W and control value V are stored in the authentication data set ADS.

Although a particular object can be identified using a single pair of helper data W and control value V, it is possible that a particular object can be identified using multiple pairs of helper data and control values. Additional helper data and control value pairs can be generated easily by selecting different property sets S. Multiple helper data and control value pairs can be particularly useful for managing access levels or for system renewal. For now assume a situation in which the authentication data set comprises only a single helper data and control value per enrolled object.

During the authentication process AUTH a (bio)metric data Y1 (fingerprint) from the physical object (not shown in FIG. 1) is acquired. In addition an alleged identity is provided. The next step is to check whether the authentication data set ADS contains a first helper data W1 and a first control value V1 for a reference object with said alleged identity. If this is the case the first helper data W1 and the first control value V1 associated with the reference object are retrieved.

Next the (bio)metric data Y1 from the physical object OBJ is combined with the first helper data W1 resulting in a first property set C1. In case the physical object corresponds to the reference object the (bio)metric data Y1 can be interpreted as a noisy version of the biometric template X:
Y1=X+N (where N is small)
The first helper data W1 can be represented by template data X and property set C:
W1=C−X
By substitution the first property set C1 can be written as:
C1=C−X+Y1
C1=C−X+X+N
C1=C+N

The first property set C1 is passed to the noise compensating mapping NCM, to produce a first property set S1. Now assume that the physical object corresponds with the reference object. As long as the noise component N present in the (bio)metric data Y1 is sufficiently small, or alternatively the noise robust mapping NRM is sufficiently robust, the inverse of the noise robust mapping NRM will reconstruct a first property set S1 that is identical to the original property set S as used during enrolment for generating the first helper data W1.

The first property set S1 is subsequently used to compute a second control value V2 in a similar fashion as the first control value V1. Next the second control value V2 is compared with the first control value V1 generated during enrolment. Provided the noise robust mapping NRM provides sufficient resilience to noise the second control value V2 will be identical to the first control value V1. If these values are identical, the authentication is successful, and the identity of the physical object OBJ is established as being the alleged identity.

The noise robust mapping NRM can be selected from a wide variety of mappings. A simple noise robust mapping NRM could involve the duplication of input symbols. In turn the noise compensating mapping NCM would require a majority vote using the received symbols. On the other end of the spectrum a more elaborate noise robust mapping NRM can be selected such as a Reed Solomon ECC encoding algorithm.

The present invention can be used for quantifying the noise introduced during the acquisition of a first metric data Y1 from a first physical object OBJ1. This noise might arise from a variety of sources such as:

1. Variations in the manufacturing process of the acquisition system;

Consider for example a network of bank authentication terminals, if over the years different sensors are used for data acquisition, the sensitivity, and or bias of such sensors may differ from terminal to terminal.

2. Variations resulting from use;

If a fingerprint acquisition means is used over a longer period of time the surface of the fingerprint scanner may become scratched or dirty.

3. Variations resulting from aging;

When a sensor ages its sensitivity and functionality may suffer from material degradation.

4. Variations resulting from environmental characteristics;

If an acquisition means for facial recognition is located in an environment with a strong ambient light this will affect the contrast of the acquired metric data.

Typically the noise resulting from 1 and 4 is time invariant, whereas the noise resulting from 2 and 3 will be slowly varying. The noise introduced by the sources 1 and 4 can be compensated for using static compensation, whereas the noise resulting from 2 and 3 requires dynamic compensation. Examples of both methods of compensation will be addressed.

FIG. 2 illustrates an apparatus APP1 for authentication of a physical object OBJ1 using both a first helper data W1 and a first control value V1 associated with a reference object arranged to generate a noise measure according to the present invention. The apparatus APP1 comprises three subblocks: an acquisition means ACQ, a noise compensating mapping means NCMM, and an establishing means (EM). Assume that the physical object corresponds with the reference object.

The noise compensating mapping means NCMM combines both the first helper data W1 and the metric data Y1 acquired by the acquisition means ACQ from the first physical object OBJ1. The resulting property set C1, is subsequently used as an input for a noise compensating mapping NCM. The output of the noise compensating mapping NCM corresponds to the first property set S1.

The first property set S1 is used by the establishing means EM to generate a third control value V3 that is matched with the first control value V1 associated with the reference object. When both control values match the authentication is successful and the physical object matches the enrolled reference object.

As the reference object and the physical object are the same, the generated first property set S1 is identical to the property set S as used during enrolment of the reference object. Subsequently the property set C generated during enrolment using the noise robust mapping on the property set S can be reconstructed.

The difference between this property set C and the property set C1 generated during authentication can be established. This difference corresponds to the difference between the template data X associated with the reference object and the metric data acquired during the authentication of the first physical object, and thus present a noise measure indicative of the acquisition noise.

The apparatus as shown in FIG. 2 can be used particularly beneficial in controlled circumstances to obtain a noise measure introduced by the acquisition means. The method to determine a noise measure NM can be enhanced to eliminate noise more efficiently.

One approach to improve reliability is to quantify multiple noise measures, preferably for multiple physical objects, and subsequently determine the arithmetic average of the various noise measures.

More elaborate schemes are possible. An example being a scheme that can isolate faulty pixels in a CCD sensor of a fingerprint scanner e.g. by scanning for pixels with a very high error rate. When an ECC encoding algorithm is used as a noise robust mapping, knowledge of errors can be used advantageously.

In general an ECC has to localize errors first before it can subsequently correct them. Although in a binary representation this is effectively the same, this is not true for messages constructed of ternary symbols, or generalized for messages constructed using symbols that can have more than two possible values. As a result knowledge of error locations can benefit the correction process allowing a larger number of errors to be corrected.

Apparatus APP1 addresses authentication, but with minor enhancements could be used for identification. In case of identification multiple objects from the authentication data set ADS, are compared with the first metric data Y1 acquired from the first physical object OBJ1. The physical object being identified does not provide an alleged identity.

Instead the identity of the physical object can be derived from the identity of the reference object that provides a sufficient match. To this end APP1 could be extended with an identity establishing means, that can retrieve the identity of the reference object from the authentication data set ADS, and can, based on the decision DEC, establish the identity of the first physical object (OBJ1) to be identical to that of the reference object.

FIG. 3 depicts an apparatus APP2 for authentication of a physical object arranged to receive a noise measure NM, generated according to the present invention, using a noise measure receiving means NMRM. The noise measure NM is subsequently used during the authentication of a second physical object OBJ2. The key difference between this apparatus and the authentication part of the apparatus depicted in FIG. 1 is the use of the noise measure NM.

The noise measure NM is used in the generation of property set C2 to compensate for noise added by the acquisition means. In doing so more headroom is provided for coping with transient and intermittent noise factors.

The property set C2 is generated by means of the weighted addition of a second helper data W2, a second metric data Y2 acquired from a second physical object, and the aforementioned noise measure NM.

The respective inputs are weighed for two reasons:

1. Generalization of helper data generation

2. Scaling of the noise measure can be used to improve system robustness

In the figure description of FIG. 1 helper data W was generated during enrolment by calculating the helper data W using:
W=C−X
Subsequently C1 was calculated by calculating:
C1=W+Y1
In FIG. 2 the generation of helper data is generalized and defined as:
W2=c₁C−c₂X
Consequently a property set C2 can be calculated using:
C2=c₃W2+c₄Y2
Further substitution of
Y2=X+N
yields:
C2=c₁c₃C−c₂c₃X+c₄X+c₄N

If the coefficients c₁ to c₄ are chosen such that c₄=c₂c₃, and c₁c₃=1 then the property set C2 is independent of X. As a result the helper data W2 can be used to provide an input for a noise compensating mapping that can be used to recover the property set C generated during enrolment. As a result an apparatus applying such a generalization requires additional weighing factors for calculating the property set C2 as shown in FIG. 3.

FIG. 4 depicts an apparatus APP3 for authentication of a second physical object OBJ2, arranged to receive a noise measure NM generated according to the present invention. This particular embodiment employs a systematic ECC decoding algorithm as the noise compensating mapping. The noise measure NM is used in the authentication of a second object OBJ2 and to generate a new noise measure NNM. The property set C2 is generated analogous to that in apparatus APP2.

The noise measure NM is also used in generating a new noise measure NNM that is valid only when the authentication process is successful. In that case the physical object is known to correspond with the reference object. As a result we can quantify the difference between the input of the noise compensating mapping NCM as used during authentication, and the output of the noise robust mapping NRM as generated during the enrolment of the reference object using the input and outputs of the noise compensating mapping NCM.

Apparatus APP3 capitalizes on the fact that the noise compensating mapping applied here is a systematic ECC decoding algorithm. A systematic ECC is an ECC where both the input and output are defined using the same alphabet and where in the input and output data and parity symbols are formatted in the same fashion. In a codeword of a systematic ECC, the data symbols are included without further coding, and can be recognised as such.

A systematic ECC decoding algorithm maps a noisy codeword that may contain symbol errors onto the closest valid codeword, where data and parity match. Provided the ECC is robust enough, or conversely the number of errors small enough this will be the original noise-free codeword. Subsequent encoding of the decoder output with the corresponding ECC encoding algorithm will map the codeword onto itself.

Consequently, when a systematic ECC decoder algorithm is used as noise compensating mapping and authentication is successful, the second property set S2 will be identical to the property set C as generated during enrolment. As a result establishing the difference between the input of the noise compensating mapping NCM and the output of the noise robust mapping NRM as generated during the enrolment of the reference object corresponds to calculating the difference between the second property set S2 and the property set C2.

The weighted addition further includes the negated weighted noise measure NM that was used to compensate for the acquisition noise in the generation of the property set C2. The result is a new noise measure NNM, that can serve as a noise measure NM during further authentications, or can instead be used as input for further processing steps to acquire a more reliable noise measure.

FIG. 5 depicts a block diagram of a system for authentication of a physical object arranged to use a noise measure generated according to the present invention. The system comprises at least one server SRV1 and at least one client CL1. The server SRV1 and client CL1 communicate over a network NET, this network could be a private network, or a public network such as the internet. In particularly in the latter case additional security measures are required to prevent a man in the middle, or a replay attack.

Assume the system utilizes a private network and that the servers are used for storing the authentication data set ADS comprising the helper data and control values of enrolled objects.

When a second physical object OBJ2 is offered for authentication the client CL1 obtains a second alleged identity AID2, and acquires a second metric data Y2 associated with the second physical object. The second alleged identity AID2 is passed by the client CL1 over the network NET to the server SRV1. In return the server SRV1 passes both a second helper data W2 and a second control value V2 associated with a reference object with the alleged identity AID2 over the network to the client CL1. In addition to this the server also provides a noise measure NM associated with the client CL1.

The client CL1 in turn receives all this information over the network NET, and uses it to complete the authentication process, analogous to apparatus APP2 as depicted in FIG. 3.

In case the client CL1 also supports the generation of a new noise measure NNM, analogous to the apparatus APP3 shown in FIG. 4 this can be reported back to server SRV1 by means of the network NET. Subsequently the server SRV1 can analyse the noise measures and use it as a diagnostics for signalling clients whose noise measures structurally exceed a pre-determined threshold value.

If diagnostics are not required and the client ascertains whether or not the noise measures structurally exceed a pre-determined threshold value, there is no need for centralizing the noise measure storage. In fact in such a case it is preferable to store the noise measure locally where it is used, in the client CL1. As a result the network load resulting from the authentication process will be kept to a minimum.

FIG. 5 further illustrates the use of a noise measure database NMDB for storing noise measures established during the authentication process. The stored noise measures SNM can be retrieved for further analysis and establishing trends in the acquisition noise.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of authenticating a first physical object (OBJ1) using a first helper data (W1) and a first control value (V1) associated with a reference object, the method comprising the following steps:
acquiring metric data (Y1) of the first physical object (OBJ1);
generating a first property set (S1) using a noise compensating mapping (NCM) on input data derived from information comprising the first helper data (W1) and the metric data (Y1);
establishing a sufficient match between the first physical object (OBJ1) and the reference object using the first property set (S1) and the first control value (V1);
the method further characterized in that it comprises a step to generate a noise measure (NM) quantifying the noise introduced during data acquisition, said step comprising the following sub-steps:
reconstructing the output of a noise robust mapping (NRM) as generated during the enrolment of the reference object using the noise compensating mapping (NCM); and
generating the noise measure (NM) by calculating the difference between the input to the noise compensating mapping (NCM) during authentication and the reconstructed output of the noise robust mapping (NRM) as generated during the enrolment of the reference object.

2. A method as claimed in claim 1, where the sub-step for reconstructing the output of the noise robust mapping (NRM) as generated during enrolment of the reference object corresponds to the generation of the first property set (S1).

3. A method as claimed in claim 1, where the sub-step for reconstructing the output of the noise robust mapping (NRM) as generated during the enrolment of the reference object involves the application of the noise robust mapping (NRM) on the first property set (S1).

4. A method as claimed in claim 1, where the step for generating input data for the noise compensating mapping (NCM) comprises the weighted addition of the first helper data (W1) and the metric data (Y1).

5. A method as claimed in claim 1, where the step for generating input data for the noise compensating mapping (NCM) comprises the weighted addition of the first helper data (W1), the metric data (Y1), and a previously generated noise measure (NM).

6. A method as claimed in claim 1, where the noise robust mapping (NRM) comprises an error correcting code encoding method.

7. A method as claimed in claim 1, where the noise compensating mapping (NCM) comprises an error correcting code decoding method.

8. A method as claimed in claim 1, where the noise measure (NM) is stored for later reference.

9. A method as claimed in claim 1, where the step for generating the noise measure (NM) further comprises a sub-step for retrieving at least one stored noise measure (SNM).

10. A method as claimed in claim 1, where the step for generating the noise measure (NM) further comprises calculating an average of the noise measure (NM) and the at least one stored noise measure (SNM).

11. Use of the method as claimed in claim 1 for calibrating an apparatus for authentication of a second physical object (OBJ2) using a second helper data (W2) and a second control value (V2) associated with a reference object.

12. Use of the method as claimed in claim 1 for calibrating an apparatus for identification of a second physical object (OBJ2) using a second helper data (W2) and a second control value (V2) associated with a reference object.

13. A method of identifying a first physical object (OBJ1) using a first helper data (W1) and a first control value (V1) associated with a reference object, the method according to claim 1, further comprising a step for establishing the identity of the first physical object (OBJ1) as being identical to that of the reference object.

14. An apparatus for authentication of a second physical object (OBJ2) using both a second helper data (W2) and a second control value (V2) associated with a reference object that comprises:
a noise measure receiving means (NMRM) arranged to receive a noise measure (NM) generated using the method claimed in claim 1;
a noise compensating mapping means (NCMM) arranged to generate a second property set (S2) using a noise compensating mapping (NCM) on the result of a weighted addition of a second metric data (Y2) acquired from the second physical object (OBJ2), the second helper data (W2), and the noise measure (NM).

15. An apparatus as claimed in claim 14, where the apparatus further comprises a noise measure generation means arranged to generate a new noise measure (NNM) by applying the steps:
acquiring metric data (Y1) of the first physical object (OBJ1);
generating a first property set (S1) using a noise compensating mapping (NCM) on input data derived from information comprising the first helper data (W1) and the metric data (Y1);
establishing a sufficient match between the first physical object (OBJ1) and the reference object using the first property set (S1) and the first control value (V1);
the method further characterized in that it comprises a step to generate a noise measure (NM) quantifying the noise introduced during data acquisition, said step comprising the following sub-steps:
reconstructing the output of a noise robust mapping (NRM) as generated during the enrolment of the reference object using the noise compensating mapping (NCM); and
generating the noise measure (NM) by calculating the difference between the input to the noise compensating mapping (NCM) during authentication and the reconstructed output of the noise robust mapping (NRM) as generated during the enrolment, of the reference object.

16. An apparatus for identification of a second physical object (OBJ2) using both a second helper data (W2) and a second control value (V2) associated with a reference object that comprises:
a noise measure receiving means (NMRM) arranged to receive a noise measure (NM) generated using the method claimed in claim 13;
a noise compensating mapping means (NCMM) arranged to generate a second property set (S2) using a noise compensating mapping (NCM) on the result of a weighted addition of a second metric data (Y2) acquired from the second physical object (OBJ2), the second helper data (W2), and the noise measure (NM);
an identity establishing means arranged to establish the identity of the first physical object (OBJ1) as being identical to that of the reference object.

17. A system for authentication of a second physical object (OBJ2) using both a second helper data (W2) and a second control data (V2) associated with a reference object, the system comprising at least one server (SRV1) and at least one client (CL1) connected by means of a network (NET), the at least one client (CL1) arranged to use a noise measure (NM) generated by means of the steps as claimed in claim 1, for compensating an acquisition noise component introduced during data acquisition by the at least one client (CL1).

18. A system as claimed in claim 17, that is arranged to generate a new noise measure (NNM) for use in a further authentication by the at least one client (CL1) of a further physical object using both a further helper data and a further control data.

19. A system as claimed in claim 17, where the at least one server (SRV1) is arranged to generate the noise measure (NM), and where the at least one client (CL1) is arranged to obtain the noise measure (NM) from the at least one server (SRV1) over the network (NET).

20. A computer program product comprising program code means stored on a computer readable medium for performing the method as claimed in claim 1, when said program product is executed on a computer.
